(19) United States
(12) Patent Application Publication
(10) Pub. No.: US 2025/0313519 A1
(43) Pub. Date: Oct. 9, 2025

(54) PROPELLANT COMPOSITION WITHOUT ACTIVATED COPPER CHROMITE HAVING A HIGH BURN RATE AND ITS USE THEREOF IN PYROGEN IGNITERS FOR LARGE ROCKET MOTORS

(71) Applicant: CHAIRMAN, DEFENCE RESEARCH & DEVELOPMENT ORGANISATION (DRDO), New Delhi (IN)

(72) Inventors: Isaac Kingstone Lesley JABEZ, Hyderabad (IN); Urmila DAS, Hyderabad (IN); Sudarshan NAKKA, Hyderabad (IN); Ramaguru GURUSAMY, Hyderabad (IN); Rama Manohara Babu MULAKALURI, Hyderabad (IN)

(73) Assignee: CHAIRMAN, DEFENCE RESEARCH & DEVELOPMENT ORGANISATION (DRDO), New Delhi (IN)

(21) Appl. No.: 18/863,314

(22) PCT Filed: Apr. 28, 2023
(86) PCT No.: PCT/IN2023/050418

§ 371 Date: Nov. 5, 2024

(30) Foreign Application Priority Data
May 6, 2022 (IN) 202211026435

(51) Int. Cl. C06B 33/12; C06B 45/10; F02K 9/95

(52) U.S. Cl. CPC C06B 33/12; C06B 45/10; F02K 9/95

(57) ABSTRACT

The present invention relates to propellant composition free from Activated Copper Chromite (ACR) having a high burn rate comprising only 0.1-0.25% of Iron oxide (Fe₂O₃) as burn rate catalyst. Particularly, it relates to the use of propellant composition for use in pyrogen igniters for large rocket motors. The propellant composition is devoid of Activated Copper Chromite catalyst, achieves a high burn rate, fulfils requirements of physical, mechanical and ballistic properties, has stable combustion and ensures reliable performance of the pyrogen igniters of large Rocket Motors.

### FIELD OF INVENTION

The present invention relates to propellant composition free from Activated Copper Chromite (ACR) having a high burn rate. Particularly, it relates to the use of propellant composition for use in pyrogen igniters for large rocket motors.

### BACKGROUND OF INVENTION

A propellant is a composition of matter comprising at least one fuel and at least one oxidizer. The reduction/oxidation (redox) reaction between the fuel and oxidizer provides energy, frequently in the form of evolved gas, which is useful in providing an impulse to move a projectile such as a rocket or spacecraft. The present invention provides propellant compositions, which are totally free from Activated Copper Chromite (ACR), yet capable of achieving very high burn rates.

Pyrogen Igniters for large rocket motors are used to generate required heat-flux and pressure within the Rocket motor in the shortest possible time in order to ensure sustained combustion of Rocket Motor. To accomplish this, propellant grain of Pyrogen Igniter must have burn rate as high as 16±0.5 mm/sec at a pressure of 70 kgf/cm². In order to achieve such a high burn rate, oxidizer is used in tri-modal (coarse, fine & ultrafine) form and besides that mixed catalysts usually ACR (Activated Copper Chromite) and Iron Oxide (Fe₂O₃) are also used. Accordingly, existing formulation of Pyrogen Igniters contains oxidizer in coarse, fine and ultrafine form and both ACR & Fe₂O₃ as burning rate catalysts. ACR exhibits undesirable catalytic activity in promoting the degradation of cross-linked HTPB binder of the propellant which has unsaturation in the backbone. As a result, it is observed that ACR based propellant grains show faster degradation limiting the overall life of Pyrogen Igniter.

IN217041(1091/MAS/1991) relates to a composite solid propellant composition with improved burn rate. Crystalline ferric oxide is added as ballistic modifier to conventional propellant composition having hydroxyl terminated. polybutadiene, aluminium powder and ammonium perchlorate. However, the AP oxidizer used is bimodal (coarse and fine). It is fact that bimodal AP oxidizer even with maximum possible fine content cannot yield burn rate higher than 12 mm/sec at 70 kgf/cm². If at all burn rate of 12 mm/sec at 70 kgf/cm² is achieved with bimodal AP oxidizer, the resultant viscosity of propellant slurry, make it impossible to cast the propellant. Thus, the propellant composition in this patent cannot meet the burn rate requirements of 16 mm/sec at 70 kgf/cm² required for Pyrogen Igniters of large Rocket Motor.

Babu, KV Suresh, et al. “Studies on composite solid propellant with tri-modal ammonium perchlorate containing an ultrafine fraction.” Defence technology 13.4 (2017): 239-245 provides Composite solid propellant compositions. However it achieves a maximum burn rate of 10.08 mm/sec at 70 kgf/cm² which is lower than the burn rate requirements of 16 mm/sec at 70 kgf/cm² required for Pyrogen Igniters of large Rocket Motor.

Sangtyani, Rekha, et al. “An alternative approach to improve burning rate characteristics and processing parameters of composite propellant.” Combustion and Flame 209 (2019): 357-362, gives propellant formulation. However, the maximum burn rate achieved is of 10 mm/sec at 70 kgf/cm² (as per FIG. 1) with 1.5% of iron oxide. Such a high iron oxide % must have effect on viscosity & mechanical properties which is undesirable. Therefore, the claims of this publication are not applicable with respect to the requirements posed by Pyrogen Igniter for large Rocket motor.

Patent CA1056984 relates to solid propellant compositions comprising (A) a binder containing (1) a hydroxy-terminated polybutadiene, (2) a diisocyanate curing agent. (3) a reaction product of an aziridinyl phosphine oxide and a polycarboxylic acid and (4) a reaction product of an alkanolamine and a saturated aliphatic polycarboxylic acid and dispersed therein (B) finely divided ammonium perchlorate, preferably in a di- or trimodal distribution of particle sizes between 1 and 400 Ám. This patent uses ingredients of specialized nature, whose batch to batch consistency in quality is uncertain, whereas propellant composition of the present invention employs indigenously available conventional ingredients and thus suitable for mass production of Pyrogen Igniters of large Rocket Motors. Further, this patent uses a higher amount of iron oxide catalyst of 0.6%. Increase in % of IO has marked effect on the viscosity of the propellant slurry & also on achievability of mechanical properties, especially on E-modulus. Therefore, using IO of 0.6% would be highly unacceptable in terms of propellant slurry viscosity & achieved mechanical properties. Further, the particle sizes of AP fractions (400μ, 200μ & 17μ) as given in this patent raises strong skepticism over achievability of 16 mm/sec at 70 kgf/cm² even at 0.6% of IO, which too is not acceptable for the given end application. Thus, composition of PatentCA1056984 cannot meet the requirements of Pyrogen Igniters of large Rocket Motors.

Therefore, there is a need to develop ACR free propellant compositions having a high burn rate, fulfilling requirements of physical, mechanical and ballistic properties, having stable combustion and reliable performance of the pyrogen igniter, while keeping the burn rate catalyst within 0.25%. The present inventors have surprisingly developed an efficient propellant composition without ACR and with only Iron Oxide (Fe₂O₃) of just 0.1 to 0.25% as ballistic modifier/burn rate catalyst, that supersedes all prior art which use only Iron Oxide (Fe₂O₃) as ballistic modifier/burn rate catalyst or employ mixed catalysts (Iron Oxide (Fe₂O₃) and activated copper chromite) in the following aspect: The propellant composition of the present invention can achieve burn rate as high as 16±0.5 mm/sec at 70 kgf/cm² with only Iron Oxide (Fe₂O₃) as ballistic modifier/burn rate catalyst, whereas all other prior art that uses only Iron Oxide (Fe₂O₃) as ballistic modifier/burn rate catalyst can achieve burn rate much lower than 12 mm/sec that too with Fe₂O₃ content as high as 0.6% or it has to employ mixed catalysts (Iron Oxide (Fe₂O₃) and activated copper chromite) to achieve 16 mm/sec burn rate. Given the necessity to do away with activated copper chromite (ACR) (as ACR suffers with non-reproducibility and ACR based propellant shows faster deterioration) and yet achieve higher burn rate of 1610.5 mm/sec at 70 kgf/cm² with catalyst % of 0.25 maximum, present invention is the panacea as no other prior art fulfills this need.

### Objects of the Invention

It is an object of the present invention to provide a propellant composition having a high burn rate.

It is another object of the present invention to provide an ACR-free propellant composition having iron oxide (Fe₂O₃) of just 0.1 to 0.25% as the catalyst.

It is yet another object of the present invention to provide a propellant composition which fulfills requirements of physical, mechanical and ballistic properties and ensures stable combustion and reliable performance of the pyrogen igniter.

### SUMMARY OF THE INVENTION

According to an aspect of the present invention there is provided a propellant composition having a high burn rate.

According to an aspect of the present invention there is provided a pyrogen igniter of a large rocket motor comprising propellant composition having a high burn rate of present invention.

### BRIEF DESCRIPTION OF THE DRAWINGS

The above and other aspects, features and advantages of certain exemplary embodiments of the present invention will be more apparent from the following description taken in conjunction with the accompanying drawings wherein:

FIG. 1 illustrates Specimens for testing Strand Burn Rate

FIG. 2: Strand Burn Tester

FIG. 3: Propellant Casting Technique

FIG. 4: Pressure vs. Time curve obtained during Static Test

### DETAILED DESCRIPTION OF THE INVENTION

The following description with reference to the accompanying drawings is provided to assist in a comprehensive understanding of exemplary embodiments of the invention. It includes various specific details to assist in that understanding but these are to be regarded as merely exemplary.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the scope of the invention as defined by the appended claims and their equivalents.

It is to be understood that the singular forms “a,” “an,” and “the” include plural referents unless the context clearly dictates otherwise.

Features that are described and/or illustrated with respect to one cmbodiment may be used in the same way or in a similar way in one or more other embodiments and/or in combination with or instead of the features of the other embodiments.

It should be emphasized that the term “comprises/comprising” when used in this specification is taken to specify the presence of stated features, steps or components but does not preclude the presence or addition of one or more other features, steps, components or groups thereof.

The present invention relates to propellant composition having a high burn rate. Particularly, it relates to the use of propellant composition for use in pyrogen igniters for large rocket motors.

ACR based propellant grains lead to faster deterioration thereby limiting the overall life of Pyrogen Igniter. The compositions of present invention provide a burn rate ranging from 15.69 to 18.63 mm/sec at 70 kg-f/cm² pressure while having Fe₂O₃ as catalyst and Ammonium Perchlorate (AP) oxidizer in trimodal form. The catalyst viz. iron oxide (Fe₂O₃) improves the ageing resistance thereby prolong the life of propellant and hence the overall life of Pyrogen Igniter is augmented. Further, by tailoring the particle size distribution of oxidizer (AP) in its fine and ultrafine forms and ratio of coarse:fine:ultrafine forms of oxidizer (AP) such that the reduction in burn rate due to above less reactive catalyst is overcome while ensuring propellant slurry viscosity is well within the castable limit so as to cast defect free propellant grains. The present propellant composition has a perfect balance between ratio of Coarse:Fine:Ultrafine forms of oxidizer and the quantity of catalyst so that required higher burn rate is achieved with least possible quantity of catalyst Fe₂O₃.

The cross-linker to chain extender weight ratio in the formulation is suitably adjusted without unduly increasing ˜NCO/˜OH ratio (Rvalue) (˜NCO/˜OH (R value is maintained within 0.77-0.85 only) so that the required mechanical properties of propellant are achieved despite the absence of active catalyst such as ACR (which will promote degradation of binder).

The present invention provides a propellant composition comprising:
i. Hydroxyl Terminated Polybutadiene (HTPB) polymeric binder ranging from 11.8 to 12.2%;
ii. Isocyanate curing agent ranging from 0.58 to 0.98%;
iii. Aluminium powder fuel of 2.0%;
iv. Ammonium perchlorate (AP) oxidiser ranging from 80.9 to 81.25%;
v. Iron oxide (Fe₂O₃) catalyst ranging from 0.1 to 0.25%; and
vi. Additives;
   Wherein, AP oxidiser has a trimodal distribution comprising a mixture of coarse (C), fine (F) and ultrafine (UF) particles in a ratio ranging from 0.30:0.37:0.33 to 0.32:0.35:0.33.

In an embodiment, mean diameter of the coarse particles of AP oxidiser ranges from 210 to 300 μm, fine particles ranges from 36-40 μm and ultrafine particles ranges from 7-11 μm.

In an embodiment, HTPB has OH value varying from 40-50 mg KOH/g, viscosity at 30° C. of 4000-6500 cps

In an embodiment, the isocyanate curing agent is selected from Toluene diisocyanate (TDI).

The weight ratio of HTPB to isocyanate curing agent is maintained such that the NCO/OH ratio (R ratio) is in the range of 0.77-0.85.

In an embodiment, mean diameter of the aluminium powder ranges from 12-18 μm.

The propellant composition of present invention comprises conventional additives such as plasticizer, cross-linker, chain extender and antioxidants.

In an embodiment, the plasticizer is selected from Dioctyl adipate (DOA).

In an embodiment, the cross-linker is selected from Trimethylol propane (TMP).

In an embodiment, the chain extender is selected from 1,4 butane diol (BDO).

In an embodiment, the antioxidant is selected from Phenyl β-Naphthyl Amine (PBNA).

The present invention also provides pyrogen igniter of a large rocket motor comprising the propellant composition of high burn rate of present invention.

### Advantages of Present Invention

Invention renders provision for casting of only Fe₂O₃ (non-ACR) based defect free propellant grains for pyrogen igniters (whose propellant grains weigh as high as 13.8 kg) that are required for ignition of large Rocket Motors of propellant weight 52000 kg.
Present formulation using catalyst viz. iron oxide (Fe₂O₃) improves the ageing resistance thereby prolong the life of propellant and hence the overall life of Pyrogen Igniter is augmented. This will bring respite to long range missile programs, as it will prolong the life of propellant grain thereby the life of Pyrogen Igniters and the missile as a whole.
Achieves burn rate as high as 16±0.5 mm/sec at a pressure of 70 kgf/cm² with % of Fe₂O₃ as low as 0.1-0.25.
Propellant slurry viscosity is well within the processible limit so as to cast defect free propellant grains.
Fulfils requirements of physical, mechanical and ballistic properties, has stable combustion and ensures reliable performance of the pyrogen igniter.

### EXAMPLES

The following examples are meant to illustrate the present invention. The examples are presented to exemplify the invention and are not to be considered as limiting the scope of the invention.

### Example-1

Physical, mechanical, ballistic properties as required by propellant grains of Pyrogen Igniters of large Rocket Motors, which are as detailed in Table-1.

TABLE 1
Requirements of Physical, Mechanical & Ballistic Properties

| Properties | Requirements | |
|---|---|---|
| Hardness (Shore-A) | 40 | (min) |
| Density (g/cm³) | 1.65 ± 0.05 | |
| Tensile Strength (Kg/cm²) | 5.0 | (min) |
| Elongation (%) | 30 | (min) |
| E Modulus (Kg/cm²) | 30 | (min) |
| Strand Burn Rate @70 kg-f/cm² | 16 ± 0.5 | |
| (mm/sec) | | |
| Pressure Exponent (n- value) | 0.4 | (max) |

Formulation of present invention comprises Hydroxyl Terminated Polybutadiene (HTPB) of OH value varying from 40-50 mg KOH/g, viscosity at 30° C. of 4000-6500 cps as binder, Toluene diisocyanate (TDI) as curative, Dioctyl adipate as plasticizer. Trimethylol propane (TMP; cross linker) & 1.4 butane diol (BDO; chain extender) based adduct, Phenyl β-Naphthyl Amine (PBNA) as antioxidant, Aluminium powder of mean diameter 12-18 μm as metallic fuel. Tri-modal Ammonium Perchlorate as oxidizer (Coarse of mean diameter 220±10 μm & 280±20 μm, fine of mean diameter 36-40 μm & ultrafine of mean diameter 7-11 μm). The Fe₂O₃ catalyst is procured from BASF (denoted as Type I) and Sigma Aldrich (denoted as Type II).

Formulations claimed in the present invention are detailed in Table-2.

TABLE 2
Compositions

| | Weight % | | | | |
|---|---|---|---|---|---|
| | Formulation- | Formulation - | Formulation - | Formulation - | Formulation - |
| Ingredients | 1_{(Reference/Control)} | 2 | 3 | 4 | 5 |
| HTPB + | 12.78 ± 0.02 | 12.78 ± 0.02 | 12.78 ± 0.02 | 12.78 ± 0.02 | 12.78 ± 0.02 |
| TDI | | | | | |
| DOA | 3.8 ± 0.02 | 3.8 ± 0.02 | 3.8 ± 0.02 | 3.8 ± 0.02 | 3.8 ± 0.02 |
| Adduct | 0.12 | 0.12 | 0.12 | 0.12 | 0.12 |
| PBNA | 0.1 | 0.1 | 0.1 | 0.1 | 0.1 |
| Al Powder | 2.0 | 2.0 | 2.0 | 2.0 | 2.0 |
| AP | 81.2 ± 0.05 | 80.95 ± 0.05 | 81.1 ± 0.05 | 80.95 ± 0.05 | 81.05 ± 0.05 |
| AP(C): | 0.30 | 0.30 | 0.30 | 0.32 | 0.32 |
| AP(F): | 0.37 | 0.37 | 0.37 | 0.35 | 0.35 |
| AP(UF) | 0.33 | 0.33 | 0.33 | 0.33 | 0.33 |
| Fe₂O₃Type-I | Nil | 0.25 | 0.1 | Nil | 0.15 |
| Fe₂O₃Type-II | Nil | Nil | Nil | 0.25 | Nil |

Mean diameter of AP(C) used is 220 ± 10 μm for formulation- 1 to 3 and 280 ± 20 μm for formulation-4 & 5.

### Mixing Process:

AP (Oxidizer) is dried in rotary vacuum dryer at 60-65° C. under vacuum. Surface moisture of the same is ensured to be 0.05% max before using the same for preparation of AP fine AP (F) & ultrafine AP (UF). AP (F) of particle size 36-40 μm is achieved in pulverizer. AP (UF) of mean diameter 7-11 μm is achieved in fluidizing mill/Micronizer. TMP & BDO are dried in order to decrease their moisture content to less than 0.10%. Adduct is prepared by dissolving TMP and BDO in suitable weight proportions. % Moisture content of adduct is ensured to be 0.10% maximum.

Sigma mixer of capacity 20 liters was used for the mixing of propellant as per formulation 1 to 5. Mixing was carried out in two phases viz. premixing & final mixing.

During premixing, all liquid ingredients viz. HTPB. DOA, Adduct are added in the beginning and mixed for 10±5 minutes followed by additional mixing for 30±10 minutes under vacuum of 1.5 torr. Then, PBNA is added and mixing is continued for 10±5 minutes. Thereafter. Fe₂O₃ is added in case of formulation 2 to 5 and mixing is continued for 10±5 minutes. Formulation-1 contains no Fe₂O₃. This is followed by the addition of Aluminium powder in two instalments and mixing for 10±5 minutes after addition of each instalment. Thereafter, AP oxidizer is added & mixed in six instalments; starting with ultrafine addition in two instalments & mixing for 10±5 minutes after addition of each instalment, followed by addition of fine in two instalments & mixing for 10±5 minutes after addition of each instalment and then addition of coarse in two instalments & mixing for 10±5 minutes after addition of each instalment. Thereafter, compensation is given for the quantity of HTPB which got stuck in the walls of the container (due to its viscous nature) & mixing is continued for one hour followed by additional one hour mixing under vacuum of 1.5 torr. Homogeneity of the premix is checked at this stage and % AP content & % Al powder content are ensured to be 80.85 to 81.2 & 1.95 to 2.05 respectively.

During premixing, rpm of the sigma mixer is maintained within 17. At the end of premixing, vacuum is applied in the sigma mixer after ensuring lid is tightly closed & propellant slurry is left in the sigma mixer under vacuum overnight. At the end of premixing, temperature of the propellant slurry is maintained within 40±2° C.

On the next day, propellant slurry is warmed up by keeping the mixer in the running condition for 30 minutes at rpm of 17 so as to increase propellant slurry temperature to 37±1° C. Thereafter, curative TDI is added & mixing is continued at rpm of 21 for 40±10 minutes. Temperature of the propellant slurry during final mixing is controlled such that at the end of mixing, temperature of propellant slurry is within 40±2° C.

End of mixing viscosity at the given propellant mass temperature at that instance & viscosity build up trend for every 30 minutes, subsequently as the propellant slurry is maintained at 40° C., are given in Table-3.

TABLE 3
Viscosity of Propellant Slurry achieved of Various Formulation

| | Viscosity (Poise) | | | | |
|---|---|---|---|---|---|
| Time/ | Formulation- | Formulation - | Formulation - | Formulation- | Formulation- |
| Instances | 1 | 2 | 3 | 4 | 5 |
| End of | 5760 @ | 9280@ 42° C. | 9760 @ | 11200 @ 42° C. | 9280@ 41° C. |
| Mixing | 42° C.* | | 42° C. | | |
| 30 minutes | 8640 | 12480 | 10240 | 16000 | 11200 |
| 60 minutes | 13280 | 13760 | 12800 | 16640 | 11200 |
| 90 minutes | 13920 | 15360 | 13440 | 11200 | 12800 |
| 120 minutes | 13920 | 17280 | 13440 | 11520 | 12320 |
| 150 minutes | 13920 | 19040 | 12800 | 10720 | 12320 |
| 180 minutes | 14080 | 20160 | 12160 | 10720 | 12320 |

*End of mixing viscosity is measured immediately at the end of mixing; therefore

respective end of mixing temperatures are given in Table-3.

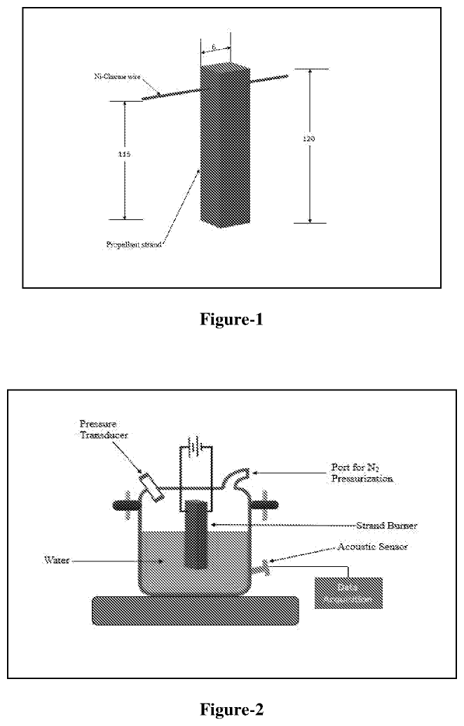

Metallic moulds with PTFE coating on the internal surface of dimensions 150 mm×150 mm×180 mm are cast with propellant slurry and cured at 50° C. in calibrated oven for 5 days in order to obtain cured propellant called carton. Thereafter, dumbbells conforming to ASTM standard are made from cartons representative of formulation-1 to formulation-5. Similarly, strand burners of dimension 120 mm×6 mm×6 mm are also made from carton representative of different formulation & pierced with Ni-chrome wire 5 mm from one end (such that effective length of strand below Ni-Chrome wire is 115 mm) as depicted in FIG. 1.

Dumbbells are tested in calibrated UTM employing a crosshead speed of 50 mm/minute. Physical properties viz. Density, Shore-A hardness & mechanical properties viz. Tensile Strength and % Elongation achieved of formulation-1 to 5 are given in Table-4.

TABLE 4
Physical & Mechanical Properties achieved of various Formulations

| | Achieved Values | | | | |
|---|---|---|---|---|---|
| | Formulation- | Formulation - | Formulation - | Formulation- | Formulation- |
| Properties | 1 | 2 | 3 | 4 | 5 |
| Hardness | 55 | 35 | 45 | 40 | 39-42 |
| (Shore-A) | | | | | |
| Density | 1.653 | 1.655 | 1.652 | 1.6565 | 1.6526 |
| (g/cm³) | | | | | |
| Tensile | 8.36-8.89 | 7.87-8.99 | 8.45-9.03 | 8.62-8.94 | 8.38-9.18 |
| Strength | | | | | |
| (Kg/cm²) | | | | | |
| Elongation | 39.6-52.5 | 39.0-54.5 | 42.7-55.3 | 48.4-53.8 | 48.2-54.5 |
| (%) | | | | | |

Strand Burn rate is evaluated using strand burn tester schematically represented in FIG. 2.

In strand burn tester, strand burner is suspended on Ni-chrome wire such that half of it is immersed inside water. Acoustic sensor captures the disturbance in water medium due to burning of the strand burner. Before the strand burner is ignited, the chamber of strand burn tester is pressurized to 70 kg-f/cm² using N₂ gas at which the burn rate has to be evaluated. Once the pressure is stabilized, ignition of strand burner is initiated by passing current through Ni-Chrome wire. Burning time of the effective length of 115 mm of strand burner is captured in the data acquisition system from the start & end of acoustic disturbance. Burn rate is calculated by dividing the effective length of strand burner by the burning time. Burn rate at 70 kg-f/cm² pressure, thus evaluated of various formulations of the inventions is given in Table-5. Pressure exponent (n value) computed of Formulation-3 and Formulation-5 of present invention are 0.367 and 0.390 respectively.

TABLE 5
Strand Burn Rate Achieved of Various Formulation

Achieved Burn Rate at 70 kg-f/cm² (mm/sec)

| Formulations | Minimum | Maximum | Average |
|---|---|---|---|
| Formulation-1 | 12.34 | 13.04 | 12.66 |
| Formulation-2 | 17.40 | 20.18 | 18.63 |
| Formulation-3 | 15.97 | 16.67 | 16.36 |
| Formulation-4 | 14.76 | 16.69 | 15.69 |
| Formulation-5 | 15.96 | 16.94 | 16.29 |

From the aforesaid Tables 3 to 5, it is observed that:
Formulation-1 (reference/control) achieves a burn rate of 12.66 mm/sec at 70 kg-f/cm² without adding any catalyst while keeping viscosity within 5760-14080 poise, which still allows casting of defect free propellant grains given that grains are cast by pressure assisted vacuum casting.
It has been further demonstrated that burn rate can be increased from 12.66 mm/sec (Formulation-1 without catalyst) to 16.36 mm/sec by adding 0.1% of Fe₂O₃ catalyst Type-I (Formulation-3).
Formulations 3 to 5 of the invention yields required burn rate of 16±0.5 mm/sec at 70 kg-f/cm² as warranted by Pyrogen Igniter of large CRMCs.
Formulation-2 is Formulation-1 with the incorporation of 0.25% Fe₂O₃ of Type-I. As evident from Tables-3 & 5, incorporation of 0.25% of Type-1 Fe₂O₃ has undesirable effect on viscosity as viscosity for formulation-2 is 9280-20160 poise as against 9760-12160 poise in case of formulation-3 (which is nothing but formulation-1 with 0.1% Fe₂O₃ Type-1). Desirable viscosity of propellant slurry is 5000 poise to 15000 poise at 40° C. However, Formulation-2 is still castable as the technique is pressure assisted vacuum casting; Further, Formulation-2 can cater for burn rate requirements slightly higher than 16 mm/sec. Further, increase in Fe₂O₃ Type-I to 0.25% (formulation-2) resulted in increase in burn rate at 70 kg-f/cm² to 18.63 mm/sec. It may be noted that in case of formulations-1, 2 & 3 AP(C) of mean diameter 220±10 μm is used and coarse to fine ratio is the same in all these 3 formulations.
Objective of Formulations-4 and 5 is primarily to reduce the viscosity of the propellant slurry and secondarily to achieve the required burn rate of 16±0.5 mm/sec at 70 kg-f/cm², while using AP (C) of higher mean diameter 280±20 μm (in lieu of 220±10 μm) whose sphericity is better. Accordingly. Course:Fine:Ultrafine ratio of AP oxidizer is changed in Formulation-4 & 5 and 0.25% Fe₂O₃ of Type-II is used in Formulation-4 and 0.15% Fe₂O₃ of Type-I is used in Formulation-5.
As evident from Table-3 & 5, Formulation-4 (with 0.25% Fe₂O₃ Type-II) yields propellant slurry of viscosity 10720-16640 poise and burn rate of 15.69 mm/sec (14.76-16.69 mm/sec) at 70 kg-f/cm². Whereas, Formulation-5 (with 0.15% Fe₂O₃ of Type-I) yields propellant slurry of appreciably lower viscosity 9280-12320 poise and burn rate of 16.29 mm/sec (15.96-16.94 mm/sec) at 70 kg-f/cm². Further, the scatter in the burn rate is also less in case of Formulation-5, with only 0.15% Fe₂O₃ of Type-I.
Above results show that Type-I Fe₂O₃ catalyst is more effective than Type-II Fe₂O₃ catalyst as the former yields required burn rate in quantity as low as 0.15%. Further, it can be understood from the above results that viscosity of propellant slurry increases with the increase in % of Fe₂O₃ and scatter in the achieved burn rate too increases with the increase in % of Fe₂O₃ irrespective of the type. That, pressure exponent is within 0.390 despite Fe₂O₃ being the only burn rate catalyst, confirms that the formulation-3 and 5 of this invention will lead to stable combustion and reliable performance.
Table-4 gives the physical & mechanical properties of various formulations. Mechanical properties, in general are dependent on the ˜NCO/˜OH Ratio (R Ratio). In all the formulations of present inventions, R ratio is maintained within 0.77-0.82. By keeping the total quantity of HTPB & TDI within 12.78±0.02%, while changing the individual quantity in such a way that R Ratio is maintained at the highest possible value of preferable range of 0.77-0.85, and by suitably altering the cross-linker to chain extender weight ratio in the adduct, it is possible to achieve the required burn rate of 16±0.5 mm/sec at 70 kg-f/cm², while ensuring that mechanical properties are well above the specification & viscosity of propellant slurry is well within the cast-able limit.
Invention offers the flexibility of using Ammonium perchlorate (AP) coarse of mean diameter as low as 220±10 μm and as high as 280±20 μm. Formulation 2 and 3 shall cater to AP(C) of lower mean diameter and Formulation-4 & 5 shall cater to AP(C) of higher mean diameter.
Type-I Fe₂O₃ used in the invention is more effective than Type-II as it facilitates the attainment of required burn rate with quantity as low as 0.15%.
As far as the requirements of Pyrogen igniter of large CRMCs are concerned & given the large size of propellant grain for Pyrogen Igniters of large CRMC (size—550 mm length, 208 mm diameter & 13.8 kg weight), Formulation-5 would offer the highest advantage as it warrants Fe₂O₃ of Type-I, as low as 0.15% & AP(C):AP(F) ratio of 0.32:0.35 (as against 0.30:0.37 in case of Formulation-1 to 3) thereby resulting in propellant slurry of viscosity 9280-12320 poise (well acceptable for pressure assisted vacuum casting and vacuum casting).
For casting of large propellant grain without any void or defect, propellant slurry viscosity should be as low as possible. In general, Fe₂O₃ based formulations result in the faster viscosity build up. All the formulations claimed of this invention offer propellant slurry of adequate pot life and viscosity starting from 5760 poise at the end of mixing and reaching a maximum of 20160 poise (only Formulation-2 viscosity reaches 20160 poise after 3 hours and other formulations viscosity is less than 20000 poise after 3 hours) at 40° C., which makes the propellant cast-able even up to 3 hours.
Pressure exponent of formulation-5 of the invention is within 0.39, thereby assures stable combustion and reliable performance of the Pyrogen igniter.
Formulations-3 to 5 of the invention yields required burn rate of 16±0.5 mm/sec at 70 kg-f/cm² as warranted by Pyrogen Igniter of large CRMCs. Present invention has demonstrated that it is possible to achieve required burn rate of 16±0.5 mm/sec at 70 kg-f/cm² pressure, with very less scatter while using AP(C) of mean diameter 280±20 μm having higher sphericity and incorporating Fe₂O₃ as low as 0.15% and yet having viscosity of propellant slurry well within 6400 poise at the end of mixing &12320 poise after 3 hours at 40° C.

### Validation of Propellant Composition According to Present Invention in Pyrogen Igniter

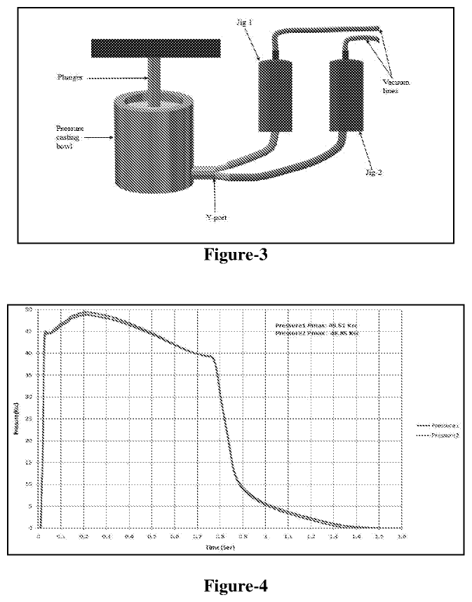

In order to prove the producibility, 90 kg production batch was run using Formulation-3 and propellant grain of one of the Pyrogen Igniter configurations (weight of grain 5 kg) was cast by pressure assisted vacuum casting technique (which is schematically represented in FIG. 3).

The Pyrogen Igniter assembled with the above propellant grain was static tested. Pressure vs. Time (PT curve) plot obtained during static test is given in FIG. 4. The performance of the Igniter is well within the predicted upper & lower bound performance. Thus. Formulation-3 got validated at the Pyrogen Igniter level performance.

Once again the repeatability & reproducibility was re-confirmed by running one 15 kg batch & one 100 kg production batch with formulation-5 of present Invention. From the 100 kg production batch, grains of one of the Pyrogen Igniter configurations were cast & one successful static test at Pyrogen Igniter level was completed. The tested physical, mechanical & ballistic properties for 15 kg batch are given in Table-6 & tested physical, mechanical & ballistic properties for 100 kg production batch are given in Table-7:

TABLE 6
Physical, Mechanical & Ballistic properties of 15 Kg re-confirmatory
batch prepared using formulation 5 of present Invention

| | | Formulation |
|---|---|---|
| Properties | Specification | (15 Kg batch) |
| Hardness (Shore-A) | 40 min | 65-66 |
| Density (g/cm³) | 1.65 ± 0.05 | 1.6530 |
| Tensile Strength | 5.0 | 10.5 |
| (Kg/cm²) (Min) | | (10.2-10.7) |
| Elongation (%) | 30 | 43.2 |
| (Min) | | (41.9-44.9) |
| E. Modulus | 30 | 42.2 |
| (Kg/cm²) (Min) | | (40.4-44.4) |
| Strand Burn Rate | 16 ± 0.5 | 16.64 |
| @70 Kg/cm 2 | | (16.23-16.91) |
| (mm/sec) | | |

1

TABLE 7
Physical, Mechanical & Ballistic properties of 100 Kg production
batch prepared using formulation 5 of present Invention

| | | Formulation |
|---|---|---|
| Properties | Specification | (15 Kg batch) |
| Hardness (Shore-A) | 40 min | 65-69 |
| Density (g/cm³) | 1.65 ± 0.05 | 1.6536 |
| Tensile Strength | 5.0 | 10.2 |
| (Kg/cm²) (Min) | | (10.0-10.5) |
| Elongation (%) | 30 | 45.2 |
| (Min) | | (42.1-47.9) |
| E. Modulus | 30 | 38.2 |
| (Kg/cm²) (Min) | | (37.0-39.9) |
| Strand Burn Rate | 16 ± 0.5 | 15.77 |
| @70 Kgf/cm² | | (15.58-16.29) |
| (mm/sec) | | |

Study to assess sensitivity of burn rate to temperature & accelerated ageing was carried out for the formulation-5 of the present invention in comparison with conventional ACR based formulation. Achieved value of Strand burn rate after soaking the specimens at 20° C. for 48 hours & 50° C. for 27 hours are given in Table-8. Similarly, mechanical properties of the specimens tested after accelerated ageing at 70° C. for 14 days, 21 days, 28 days, 35 days & 42 days are given in Table-9.

TABLE 8
Data of Temperature sensitivity

| | Strand Burn Rate Tested @ 70 kg/cm² (mm/sec) | | | | |
|---|---|---|---|---|---|
| | | Tested after | | Tested after | |
| | | Soaking at | | Soaking at | |
| | | 20° C. for 48 | % | 50° C. for 27 | % |
| Propellant | Initial Value | hours | Change | hours | Change |
| Formulation- | 15.77 | 15.61 | −1.01 | 17.04 | +8.05 |
| 5 of present | (15.58- | (15.33-15.91) | | (16.45-17.64) | |
| invention | 16.29) | | | | |
| Conventional | 15.68 | 14.89 | −5.04 | 16.97 | +8.00 |
| ACR based | (15.57- | (14.74-14.99) | | (16.24-18.49) | |
| formulation | 15.82) | | | | |

As evident from Table-8, the effect of temperature on burn rate or the sensitivity of burn rate to temperature of Formulation-5 of present invention is well comparable to that of ACR based formulation, which has been proven in several flight tests and static tests but for limitation in the overall life of Pyrogen igniters.

TABLE 9
Data of Comparative Accelerated Ageing at 70° C.

| | Formulation-5 of present invention | | | | Conventional ACR based formulation | | | |
|---|---|---|---|---|---|---|---|---|
| | | Tensile | | E. | | Tensile | | E. |
| | Hardness | Strength | Elongation | Modulus | Hardness | Strength | Elongation | Modulus |
| Withdrawal | (Shore-A) | (Kg/cm²) | (%) | (Kg/cm²) | (Shore-A) | (Kg/cm²) | (%) | (Kg/cm²) |
| Initial | 62-66 | 9.8* | 44.0 | 35.7 | 65-68 | 10.3 | 46.0 | 38.0 |
| values | | (9.02-10.2) | (34.0-47.6) | (34.1-38.3) | | (10.1-10.5) | (44.1-48.5) | (36.4-39.4) |
| Tested | 62-65 | 12.5 | 38.1 | 75.8 | 62-65 | 11.9 | 27.9 | 86.3 |
| after | | (12.4-12.7) | (36.0-39.3) | (72.8-79.8) | | (11.5-12.5) | (26.6-29.2) | (77.5-92.3) |
| ageing at | | | | | | | | |
| 70° C. for | | | | | | | | |
| 14 days | | | | | | | | |
| % change | — | +27.55 | −13.41 | +112.32 | — | +15.53 | −39.35 | +127.11 |
| Tested | 75-76 | 14.0 | 31.2 | 94.7 | 80-82 | 15.5 | 12.1 | 252 |
| after | | (13.9-14.3) | (29.4-32.8) | (89.1-97.8) | | (14.9-16.1) | (11.4-14.0) | (200-289) |
| ageing at | | | | | | | | |
| 70° C. for | | | | | | | | |
| 21 days | | | | | | | | |
| % change | — | +42.85 | −29.09 | +165.3 | — | +50.48 | −73.69 | +563.2 |
| Tested | 76-77 | 12.5 | 29.0 | 93.2 | 84-87 | 14.4 | 9.9 | 257 |
| after | | (12.0-12.7) | (28.6-29.4) | (85.6-102) | | (13.9-14.7) | (8.5-10.7) | (236-280) |
| ageing at | | | | | | | | |
| 70° C. for | | | | | | | | |
| 28 days | | | | | | | | |
| % change | — | +27.55 | −34.09 | +161.06 | — | +39.80 | −78.48 | +576.31 |
| Tested | 75-78 | 13.2 | 23.7 | 105 | 88-90 | 17.2 | 6.71 | 396 |
| after | | (12.6-13.6) | (19.3-26.0) | (101.0-107.0) | | (16.2-17.7) | (6.38-7.11) | (337-435) |
| ageing at | | | | | | | | |
| 70° C. for | | | | | | | | |
| 35 days | | | | | | | | |
| % change | — | +34.69 | −46.14 | +194.12 | — | +69.99 | −85.41 | +942.11 |
| Tested | 76-77 | 13.0 | 24.2 | 123 | 92-95 | 16.9 | 4.86 | 594 |
| after | | (12.5-13.4) | (21.4-26.7) | (118.0-129.0) | | (16.1-17.7) | (4.63-5.18) | (568-626) |
| ageing at | | | | | | | | |
| 70° C. for | | | | | | | | |
| 42 days | | | | | | | | |
| % change | — | +32.65 | −45.00 | +244.54 | — | +64.08 | −89.43 | +1463.16 |

*Average test result; value in the parenthesis indicates range of test results.

As evident from Table-9, the rate of decrease in % Elongation and increase in E Modulus with ageing at 70° C. of ACR based propellant formulation is several order higher than that of non-ACR based propellant based on Formulation-5 of present invention. Minimum required % Elongation of 30 has been retained in Formulation-5 of present invention up to 21 days of ageing at 70° C., whereas the % Elongation has got reduced to 12.1 (much lower than 30) in case of ACR based propellant after 21 days. Thus, it is evident from above that Formulation-5 of present invention has much higher ageing resistance than ACR based propellant and hence the life of Pyrogen igniters based on Formulation-5 of present invention will be much higher than 10 years.

### Technical Advancement Over Conventional Propellant Formulations in Art:

Burn Rate requirement of Pyrogen Igniters of large Rocket Motor is 16 mm/sec at 70 kgf/cm² pressure. In order to achieve burn rate of this order, trimodal AP oxidizer is mandatory if the requirement of keeping burn rate catalyst within 0.25% as required for the given end application has to be met. Coarse to fine ratio of AP oxidizer as claimed in IN217041 (1091/MAS/1991) patent is 4:1 to 2:1. Even, coarse to fine ratio of AP oxidizer of 2:1 can give a burn rate of 8-9 mm/sec at 70 kgf/cm² maximum. The achieved burn rate has not been mentioned in this patent. But it is universal fact that bimodal AP oxidizer even with maximum possible fine content cannot yield burn rate higher than 12 mm/sec at 70 kgf/cm². If at all burn rate of 12 mm/sec at 70 kgf/cm² is achieved with bimodal AP oxidizer, the resultant viscosity of propellant slurry, make it impossible to cast the propellant. Therefore, objective of IN217041 (1091/MAS/1991) patent are quite different from present invention as the burn rate requirements to be met by present invention is 16 mm/sec at 70 kgf/cm² as against probably much lower burn rate required by the IN217041 (1091/MAS/1991) patent.

Furthermore, effect of Iron Oxide % on the ageing characteristics of the propellant is neither well understood nor reported in the literature in exhaustive manner. Activated copper chromite (ACR) as burn rate catalyst with just 0.25% has led to unanticipated deterioration in mechanical properties of the cured propellant, thereby, limited the overall life of pyrogen igniter to 10 years against minimum expected life of 15 years. Therefore, apart from doing away with ACR, restricting the burn rate catalyst to maximum of 0.25% is yet another objective of the present invention. Therefore, any propellant formulation/composition with the requirement of Iron oxide %, more than 0.25% in order to achieve the required burn rate of 16 mm/sec @70 kgf/cm² is not at all acceptable for the given end application.

Sangtyani, Rekha, et al. relates to propellant formulation. As per Table-6 of this publication, burn rate of 14±0.2 mm/sec at 5 MPa is claimed to have been achieved. However, the % of Iron oxide (IO) used in the formulation & achieved mechanical properties are not disclosed. Achievement of the above burn rate with the given slurry viscosity as low as 1088 Pa·s is possible only with 10% much higher than 1.5%. Such a high 10% must have effect on viscosity & mechanical properties. Therefore, the claims of this paper are not applicable with respect to the requirements posed by Pyrogen Igniter for large Rocket motor. Following are the major deficiencies with respect to present invention's requirements:
I. 10% more than 1.5% is ruled out for present requirement.
II. Having well understood the undesirable effect of IO % over viscosity & mechanical properties through the experimental trials, IO % more than 1.5% is not at all desirable
III. Mechanical properties reported of various formulations show that E-modulus is lower than 30 kg/cm²; very few values are crossing 30 kg/cm². Whereas, in present invention, necessary innovative modification by altering cross-linker to chain extender ratio has been incorporated, thereby. E-modulus has been achieved well above 30 kg/cm².
IV. Further, pressure exponent/n-value should be less than 0.4; Formulation of this paper that meets burn rate of 14±0.2 mm/sec at 5 MPa gives n value of 0.454 (with trimodal AP oxidizer) & 0.469 (with bimodal AP oxidizer), which are not acceptable.
V. Further, this publication does not talk about temperature sensitivity of the propellant with 1.5% IO. Moreover, effect of ageing on burn rate is not fully understood. Having faced problem with respect to 0.25% ACR itself, achieving burn rate of 14±0.2 mm/sec at 5 MPa with high loading (1.5%) of IO is not at all acceptable.
VI. If catalyst loses activity, upon ageing, the propellant based on such formulation claimed in this publication would endanger the mission requirements of inventors.
VII. Formulation which is claimed to meet the end requirements of present invention, fails to furnish data based evidence. Further, it fails to furnish data to prove, if the temperature sensitivity, pressure exponent/n-value, ageing resistance, mechanical properties as offered by cured propellant are acceptable for stable operation of Pyrogen Igniter. Achieved n-value, % of IO used, confirms to a reasonable extent that, propellant based on such formulation will not meet the objective of present invention.

Thus, present invention differs appreciably from this publication. Further, present invention is driven by the end use requirements where life of Pyrogen Igniters need to be enhanced.

Achieving the burn rate as high as 16 mm/sec at 70 kgf/cm² while keeping the viscosity as low as possible & achieving required mechanical properties, is the major challenge of the present invention. As evident from literature in the art, the maximum burn rate achieved with 1.5% of IO at 70 kgf/cm² is 12 mm/sec only. Therefore, findings of various prior arts that burn rate of 14±0.2 mm/sec at 5 MPa has been achieved probably with IO much higher than 1.5%, are not acceptable for the given end application of the present invention. This is because, such a high loading of IO to the order of more than 1.5% would increase propellant slurry viscosity beyond castable limit and severely affect the attainment of requirement of E-modulus of 30 kg/cm². For example, Table-3 of the present invention shows that, viscosity with 0.1% IO of type I is 9760 poise at the end of mixing & 12160 Poise at 40° C. at the end of 180 minutes, whereas, viscosity with 0.25% IO of type I is 9280 poise at the end of mixing & 20160 Poise at the end of 180 minutes. Such prior arts do not comment on the producibility & achieved mechanical properties and actual IO % used to achieve such high burn rate.

The present inventors to achieve the required mechanical properties faced several technical challenges. Novel methodology was incorporated to counteract/nullify the effect of IO over mechanical properties without unduly increasing ˜NCO/˜OH ratio (R value) (‘R’ value was maintained well within 0.77-0.85) by suitably altering cross-linker to chain extender ratio. Required mechanical properties including E-modulus was achieved by several controlled experiments carried out with the above approach. Thus, achieving high burn rate of 16 mm/sec using trimodal AP oxidizer, only meagre amount of IO as burn rate catalyst of 0.1% to 0.25%, while keeping the slurry viscosity acceptable for casting of defect free propellant grain and achieving required tensile strength, % Elongation & E-modulus is the inventive merit of the present invention. The present invention has rendered Propellant formulation with only IO of just 0.1 to 0.25% with excellent ageing resistance.

It is to be understood that the present invention is susceptible to modifications, changes and adaptations by those skilled in the art. Such modifications, changes, adaptations are intended to be within the scope of the present invention.

1.-9. (canceled)

10. A propellant composition comprising:
i. Hydroxyl Terminated Polybutadiene (HTPB) polymeric binder ranging from 11.8 to 12.2%;
ii. Isocyanate curing agent ranging from 0.58 to 0.98%;
iii. Aluminium powder fuel of 2.0%;
iv. Ammonium perchlorate (AP) oxidiser ranging from 80.9 to 81.25%;
v. Iron oxide (Fe₂O₃) catalyst ranging from 0.1 to 0.25%; and
vi. Additives;
Wherein, the AP oxidiser has a trimodal distribution comprising a mixture of coarse (C), fine (F) and ultrafine (UF) particles in a ratio ranging from 0.30:0.37:0.33 to 0.32:0.35:0.33;
Wherein mean diameter of the coarse particles of AP oxidiser ranges from 210 to 300 pm, fine particles ranges from 36 to 40 pm and ultrafine particles ranges from 7 to 11 pm.

11. The composition as claimed in claim 1, wherein HTPB has OH value varying from 40-50 mg KOH/g, viscosity at 30° C. of 4000-6500 cps.

12. The composition as claimed in claim 1, wherein the weight ratio of HTPB to isocyanate curing agent is maintained such that NCO/OH ratio (R ratio) is in the range of 0.77-0.85.

13. The composition as claimed in claim 1, wherein the isocyanate curing agent is selected from Toluene diisocyanate (TDI).

14. The composition as claimed in claim 1, wherein additives are selected from plasticizer, cross-linker, chain extender, antioxidant and combinations thereof.

15. The composition as claimed in claim 1, wherein AP oxidiser ranges from 81.05 to 81.15%, ratio of AP (C):AP (F):AP (UF) is 0.30:0.37:0.33, mean diameter of coarse AP oxidiser ranges from 210 to 230 pm, fine particles ranges from 36 to 40 pm and ultrafine particles ranges from 7 to 11 pm and iron oxide catalyst is present at 0.1%.

16. The composition as claimed in claim 1, wherein AP oxidiser ranges from 81 to 81.1%, ratio of AP (C):AP (F):AP (UF) is 0.32:0.35:0.33, the mean diameter of coarse AP oxidiser ranges from 260 to 300 pm, fine particles ranges from 36 to 40 pm and ultrafine particles ranges from 7 to 11 pm and iron oxide catalyst is present at 0.15%.

17. The composition as claimed in claim 1, wherein the said propellant composition has a burn rate ranging from 15.69 to 18.63 mm/sec at 70 kg-f/cm2.

18. A Pyrogen igniter of a rocket motor comprising the propellant composition as claimed in claim 1.
